(19) United States
(12) Patent Application Publication
(10) Pub. No.: US 2026/0176056 A1
(43) Pub. Date: Jun. 25, 2026

(54) DEBRIS COLLECTION HOPPER SYSTEM

(71) Applicant: Stephen A. McDaniel, Winston Salem, NC (US)

(72) Inventor: Stephen A. McDaniel, Winston Salem, NC (US)

(21) Appl. No.: 19/427,355

(22) Filed: Dec. 19, 2025

Related U.S. Application Data
(60) Provisional application No. 63/736,168, filed on Dec. 19, 2024.

(51) Int. Cl. B65D 88/56; B01D 46/02; B01D 46/48; B08B 15/00

(52) U.S. Cl. CPC B65D 88/56; B01D 46/02; B01D 46/48; B08B 15/00

(57) ABSTRACT

A debris collection hopper system for collecting and emptying debris in manufacturing and industrial environments. The debris collection hopper system includes a hopper assembly for receiving and releasing collected debris. The hopper assembly is pivotably connected to a base assembly and is designed to move between an upright position and an emptying position.

### CROSS-REFERENCE TO RELATED APPLICATIONS

This application claims the benefit and priority to U.S. Provisional Patent Application No. 63/736,168 filed on Dec. 19, 2024, the entire contents of which are incorporated by reference herein.

### BACKGROUND

Industrial debris filtration and collection systems remove particulate matter, dust, and other debris from manufacturing and processing environments. These systems protect equipment, maintain air quality, and recover valuable materials. A typical debris filtration and collection system includes filter media, such as filter bags, which capture airborne debris, and collection containers positioned at discharge points to receive the captured material. The collection containers accumulate debris over time and require periodic emptying to maintain system operation.

During operation, debris passes through a debris collection system and accumulates in the collection container below. When the container reaches capacity, operators halt system operation, remove the collection container, and empty the collection container via a dropout door or similar component. This operational sequence presents several technical limitations. The hinged dropout door configuration allows debris to accumulate along the door seal edges when emptying the collection container. This debris accumulation degrades the seal integrity over time, reduces the vacuum efficiency of the filtration system, and allows particulate matter to escape the sealed environment. The degraded seal requires more frequent maintenance and reduces overall system performance.

There is a need for an industrial debris collection system that overcomes these problems with current debris filtration and collection systems.

### FIELD

The present disclosure is generally related to debris filtration and collection systems, and more specifically to debris filtration and collection systems with hopper assemblies for collecting and removing debris.

### SUMMARY

According to an aspect of the present disclosure, a debris collection hopper system is provided. The debris collection hopper system comprises a hopper assembly for receiving debris, a base assembly, and a pivot assembly. The hopper assembly is rotatably connected to the base assembly via the pivot assembly. The hopper assembly is configured to move between an upright position and an emptying position via the pivot assembly. When moving from the upright position to the emptying position, the hopper assembly is configured to move vertically and horizontally relative to the base assembly.

According to aspects of the present disclosure, the debris collection hopper system includes a pivot assembly comprising a first pivot arm, a second pivot arm, and a pivot rod. The first pivot arm and the second pivot arm are on opposite sides of the hopper assembly. The pivot rod connects the first pivot arm and the second pivot arm. The hopper assembly is configured to pivot about the pivot rod when moving from the upright position to the emptying position. The debris collection hopper system further comprises a latching mechanism. The hopper assembly is releasably attached to the base assembly via the latching mechanism. The hopper assembly is configured to move from the upright position to the emptying position when the latching mechanism is released. The latch mechanism includes a latch arm and a latch bracket. The latch arm is configured to engage the latch bracket to secure the hopper assembly in the upright position. The base assembly comprises a plurality of wheels and a plurality of fork tubes. Each fork tube of the plurality of fork tubes is configured to receive a fork of a forklift. The hopper assembly comprises a plurality of panels forming an interior volume for receiving debris.

According to at least one aspect of the present disclosure, a debris collection hopper system is provided. The debris collection hopper system comprises a hopper assembly, a base assembly, and a pivot assembly. The hopper assembly includes a plurality of panels forming an interior volume with an open top for receiving debris. The hopper assembly is rotatably connected to the base assembly via the pivot assembly. The hopper assembly is configured to move between an upright position and an emptying position via the pivot assembly. When moving from the upright position to the emptying position, the hopper assembly is configured to move vertically and horizontally relative to the base assembly.

According to at least one aspect of the present disclosure, the debris collection hopper system includes the following features. The pivot assembly comprises a first pivot arm, a second pivot arm, and a pivot rod. The first pivot arm and the second pivot arm are on opposite sides of the hopper assembly. The pivot rod connects the first pivot arm and the second pivot arm. The hopper assembly is configured to pivot about the pivot rod when moving from the upright position to the emptying position. The debris collection hopper system further comprises a latching mechanism. The hopper assembly is releasably attached to the base assembly via the latching mechanism. The hopper assembly is configured to move from the upright position to the emptying position when the latching mechanism is released. The latch mechanism includes a latch arm and a latch bracket. The latch arm is configured to engage the latch bracket to secure the hopper assembly in the upright position. The base assembly comprises a plurality of wheels and a plurality of fork tubes. Each fork tube of the plurality of fork tubes is configured to receive a fork of a forklift.

According to at least one aspect of the present disclosure, a debris collection hopper system is provided. The debris collection hopper system comprises a hopper assembly, a base assembly, a pivot assembly, and a latching mechanism. The hopper assembly includes a plurality of panels forming an interior volume with an open top for receiving debris. The hopper assembly is releasably attached to the base assembly via the latching mechanism. The hopper assembly is rotatably connected to the base assembly via the pivot assembly. The hopper assembly is configured to move between an upright position and an emptying position via the pivot assembly. When moving from the upright position to the emptying position, the hopper assembly is configured to move vertically and horizontally relative to the base assembly.

According to some aspects of the present disclosure, the debris collection hopper system includes a pivot assembly comprising a first pivot arm, a second pivot arm, and a pivot rod. The first pivot arm and the second pivot arm are on opposite sides of the hopper assembly. The pivot rod connects the first pivot arm and the second pivot arm. The hopper assembly is configured to pivot about the pivot rod when moving from the upright position to the emptying position. The hopper assembly is configured to move from the upright position to the emptying position when the latching mechanism is released. The base assembly comprises a plurality of wheels and a plurality of fork tubes. Each fork tube of the plurality of fork tubes is configured to receive a fork of a forklift.

In some aspects, a debris collection hopper system is disclosed. The debris collection hopper system includes a hopper assembly and a support assembly. In some embodiments, the support assembly includes an actuator (e.g., electric, pneumatic). The debris collection hopper system includes a plurality of angled supports to align the hopper assembly under a debris (e.g., dust) collector. In some embodiments, the debris collector includes a plurality of filter media bags. In the aligned position, the hopper assembly is positioned to receive debris from the filter media bags and other debris collector dropouts. The support assembly is positioned (e.g., mounted) on top of at least one of the plurality of angled supports. The support assembly includes a plurality of cylinders to lift the hopper. For example, and without limitation, the cylinders push a beam fitted against a top of the cylinders. As a result, the beam presses against a lip of the hopper. In some embodiments, the beam provides a uniform pressure force to the lip of the hopper. As a result, the hopper is lifted until the hopper contacts a bottom of the dust collector to create a sealed environment.

In some embodiments, the hopper includes a plurality of handles designed for pulling and/or pushing the hopper. Advantageously, the hopper is easily transported, enabling operators to swap a first hopper for a second hopper during operation of a debris collection system. In some embodiments, the hopper includes a plurality of support members operable to receive forklift prongs. Advantageously, this enables operators to use a forklift to transport the hopper.

### BRIEF DESCRIPTION OF THE DRAWINGS

The embodiments illustrated, described, and discussed herein are illustrative of the present invention. As these embodiments of the present invention are described with reference to illustrations, various modifications or adaptations of the methods and or specific structures described may become apparent to those skilled in the art. It will be appreciated that modifications and variations are covered by the above teachings and within the scope of the appended claims without departing from the spirit and intended scope thereof. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

FIG. 1 illustrates a perspective view of a debris collection hopper system according to aspects of the present disclosure.

FIG. 2 illustrates a front view of a debris collection hopper system according to aspects of the present disclosure.

FIG. 3 illustrates a perspective view of removal of a hopper assembly of a debris collection hopper system according to aspects of the present disclosure.

FIG. 4 illustrates a perspective view of removal of a hopper assembly of a debris collection hopper system according to aspects of the present disclosure.

FIG. 5 illustrates a perspective view of an emptying operation of a hopper assembly of a debris collection hopper system according to aspects of the present disclosure.

FIG. 6A illustrates a perspective view of a hopper assembly of a debris collection hopper system according to aspects of the present disclosure.

FIG. 6B illustrates a perspective view of a hopper assembly of a debris collection hopper system with a chain according to aspects of the present disclosure.

FIG. 6C illustrates a perspective view of a hopper assembly of a debris collection hopper system according to aspects of the present disclosure.

FIG. 7 illustrates a bottom perspective view of a debris collection hopper system according to aspects of the present disclosure.

FIG. 8 illustrates a rear view of a debris collection hopper system according to aspects of the present disclosure.

FIG. 9 illustrates a rear view of a debris collection hopper system according to aspects of the present disclosure.

FIG. 10 illustrates a top view of a debris collection hopper system according to aspects of the present disclosure.

FIG. 11 illustrates a top view of a debris collection hopper system according to aspects of the present disclosure.

FIG. 12 illustrates a side planar view of a debris collection hopper system according to aspects of the present disclosure.

FIG. 13 illustrates a side view of a debris collection hopper system according to aspects of the present disclosure.

FIG. 14 illustrates a perspective view of a base assembly of a debris collection hopper system according to aspects of the present disclosure.

FIG. 15 illustrates a bottom view of a debris collection hopper system according to aspects of the present disclosure.

FIG. 16A illustrates a rear panel of a hopper assembly according to aspects of the present disclosure.

FIG. 16B illustrates a front perspective view of a rear panel of a hopper assembly according to aspects of the present disclosure.

FIG. 16C illustrates an end view of a rear panel of a hopper assembly according to aspects of the present disclosure.

FIG. 17A illustrates a left-side panel of a hopper assembly according to aspects of the present disclosure.

FIG. 17B illustrates a perspective view of a left-side panel of a hopper assembly according to aspects of the present disclosure.

FIG. 17C illustrates an end view of a left-side panel of a hopper assembly according to aspects of the present disclosure.

FIG. 18A illustrates a right-side panel of a hopper assembly according to aspects of the present disclosure.

FIG. 18B illustrates a perspective view of a right-side panel of a hopper assembly according to aspects of the present disclosure.

FIG. 18C illustrates an end view of a right-side panel of a hopper assembly according to aspects of the present disclosure.

FIG. 19A illustrates a front panel of a hopper assembly according to aspects of the present disclosure.

FIG. 19B illustrates a front panel of a hopper assembly according to aspects of the present disclosure.

FIG. 19C illustrates an end view of a front panel of a hopper assembly according to aspects of the present disclosure.

FIG. 20A illustrates a rocker of a debris collection hopper system according to aspects of the present disclosure.

FIG. 20B illustrates a perspective view of a rocker of a debris collection hopper system according to aspects of the present disclosure.

FIG. 20C illustrates an end view of a rocker of a debris collection hopper system according to aspects of the present disclosure.

FIG. 21A illustrates a rocker support angle of a hopper assembly according to aspects of the present disclosure.

FIG. 21B illustrates a rocker support angle of a hopper assembly according to aspects of the present disclosure.

FIG. 21C illustrates an end view of a rocker support angle of a hopper assembly according to aspects of the present disclosure.

FIG. 22A illustrates a perspective view of a hopper assembly base stop according to aspects of the present disclosure.

FIG. 22B illustrates a side view of a hopper assembly base stop according to aspects of the present disclosure.

FIG. 22C illustrates an end view of a hopper assembly base stop according to aspects of the present disclosure.

FIG. 23A illustrates a perspective view of a hopper base rocker angle according to aspects of the present disclosure.

FIG. 23B illustrates a planar view of a hopper base rocker angle according to aspects of the present disclosure.

FIG. 23C illustrates an end view of a hopper base rocker angle according to aspects of the present disclosure.

FIG. 24A illustrates a perspective view of a latch arm of a hopper assembly of a debris collection hopper system according to aspects of the present disclosure.

FIG. 24B illustrates a planar view of a latch arm of a hopper assembly of a debris collection hopper system according to aspects of the present disclosure.

FIG. 24C illustrates an end view of a latch arm of a hopper assembly of a debris collection hopper system according to aspects of the present disclosure.

FIG. 25A illustrates a planar view of a latch bracket of a hopper assembly according to aspects of the present disclosure.

FIG. 25B illustrates an end view of a latch bracket of a hopper assembly according to aspects of the present disclosure.

FIG. 25C illustrates a perspective view of a latch bracket of a hopper assembly according to aspects of the present disclosure.

FIG. 26A illustrates a planar view of a latch arm safety latch of a hopper assembly according to aspects of the present disclosure.

FIG. 26B illustrates an end view of a latch arm safety latch of a hopper assembly according to aspects of the present disclosure.

FIG. 26C illustrates a perspective view of a latch arm safety latch of a hopper assembly according to aspects of the present disclosure.

FIG. 27A illustrates a perspective view of a fork tube of a base assembly of a debris collection hopper system according to aspects of the present disclosure.

FIG. 27B illustrates a planar view of a fork tube of a base assembly of a debris collection hopper system according to aspects of the present disclosure.

FIG. 27C illustrates an end view of a fork tube of a base assembly of a debris collection hopper system according to aspects of the present disclosure.

FIG. 28A illustrates a perspective view of a rear component of a base assembly of a debris collection hopper system according to aspects of the present disclosure.

FIG. 28B illustrates a planar view of a rear component of a base assembly of a debris collection hopper system according to aspects of the present disclosure.

FIG. 28C illustrates an end view of a rear component of a base assembly of a debris collection hopper system according to aspects of the present disclosure.

FIG. 29A illustrates a perspective view of a front component of a base assembly of a debris collection hopper system according to aspects of the present disclosure.

FIG. 29B illustrates a planar view of a front component of a base assembly of a debris collection hopper system according to aspects of the present disclosure.

FIG. 29C illustrates an end view of a front component of a base assembly of a debris collection hopper system according to aspects of the present disclosure.

FIG. 30A illustrates a perspective view of a right frame component of a base assembly of a debris collection hopper system according to aspects of the present disclosure.

FIG. 30B illustrates an end view of a right frame component of a base assembly of a debris collection hopper system according to aspects of the present disclosure.

FIG. 30C illustrates a planar view of a right frame component of a base assembly of a debris collection hopper system according to aspects of the present disclosure.

FIG. 31A illustrates a perspective view of a left-frame component of a base assembly of a debris collection hopper system according to aspects of the present disclosure.

FIG. 31B illustrates a planar view of a left-frame component of a base assembly of a debris collection hopper system according to aspects of the present disclosure.

FIG. 31C illustrates an end view of a left-frame component of a base assembly of a debris collection hopper system according to aspects of the present disclosure.

FIG. 32A illustrates a perspective view of a pivot arm of a hopper assembly according to aspects of the present disclosure.

FIG. 32B illustrates a planar view of a pivot arm of a hopper assembly according to aspects of the present disclosure.

FIG. 32C illustrates an end view of a pivot arm of a hopper assembly according to aspects of the present disclosure.

FIG. 33A illustrates a planar view of a window of a hopper assembly according to aspects of the present disclosure.

FIG. 33B illustrates an end view of a window of a hopper assembly according to aspects of the present disclosure.

FIG. 33C illustrates a perspective view of a window of a hopper assembly according to aspects of the present disclosure.

FIG. 34A illustrates a planar view of a window frame of a hopper assembly according to aspects of the present disclosure.

FIG. 34B illustrates an end view of a window frame of a hopper assembly according to aspects of the present disclosure.

FIG. 34C illustrates a perspective view of a window frame of a hopper assembly according to aspects of the present disclosure.

FIG. 35A illustrates a latch bracket gusset of a hopper assembly according to at least one aspect of the present disclosure.

FIG. 35B illustrates an end view of a latch bracket gusset of a hopper assembly according to at least one aspect of the present disclosure.

FIG. 35C illustrates a perspective view of a latch bracket gusset of a hopper assembly according to at least one aspect of the present disclosure.

FIG. 36A illustrates a planar view of a base pivot gusset of a hopper assembly according to at least one aspect of the present disclosure.

FIG. 36B illustrates an end view of a base pivot gusset of a hopper assembly according to at least one aspect of the present disclosure.

FIG. 36C illustrates a perspective view of a base pivot gusset of a hopper assembly according to at least one aspect of the present disclosure.

### DETAILED DESCRIPTION

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a,” “an,” and “the” refer to “one or more” when used in the subject specification, including the claims. Thus, for example, reference to “a device” can include a plurality of such devices, and so forth.

Unless otherwise indicated, all numbers expressing quantities of components, conditions, and so forth used in the specification and claims are to be understood as being modified in all instances by the term “about.” Accordingly, unless indicated to the contrary, the numerical parameters set forth in the instant specification and attached claims are approximations that can vary depending upon the desired properties sought to be obtained by the presently disclosed subject matter.

According to aspects of the present disclosure, a debris collection hopper system configured for pivoting emptying operations is disclosed. The debris collection hopper system comprises a hopper assembly pivotably connected to a base assembly with a pivoting assembly (e.g., pivot arm, pivot rod). The pivoting assembly enables the hopper assembly to pivot between an upright position and an emptying position. In the upright position, the hopper assembly receives debris from a debris collector positioned above the hopper assembly. The hopper assembly is configured to interface with the debris collector to create a sealed environment during debris collection operations. In the emptying position, the hopper assembly is oriented to release accumulated debris from the interior volume of the hopper assembly.

The debris collection hopper system eliminates debris accumulation that negatively affects current debris collection systems. A hopper assembly with an open top enables debris intake during debris collection operations and debris release during emptying operations. The debris does not pass through or accumulate at a dropout component. The hopper assembly pivots forward and downward from an upright position to an emptying position, allowing gravity-assisted release of collected debris.

The debris collection hopper system includes a latch mechanism that releasably secures the hopper assembly in an upright position relative to a base assembly during debris collection operations. When an operator releases the latch mechanism, the hopper assembly pivots using a pivoting assembly (e.g., pivot arms, pivot arm) to the emptying position. After the release of collected debris, the hopper assembly returns to the upright position and the latch mechanism is engaged to secure the hopper assembly for debris collection. The base assembly includes a frame with wheels that enables transport of the debris collection hopper system and fork tubes configured to receive forklift prongs that facilitate movement of the debris collection hopper system.

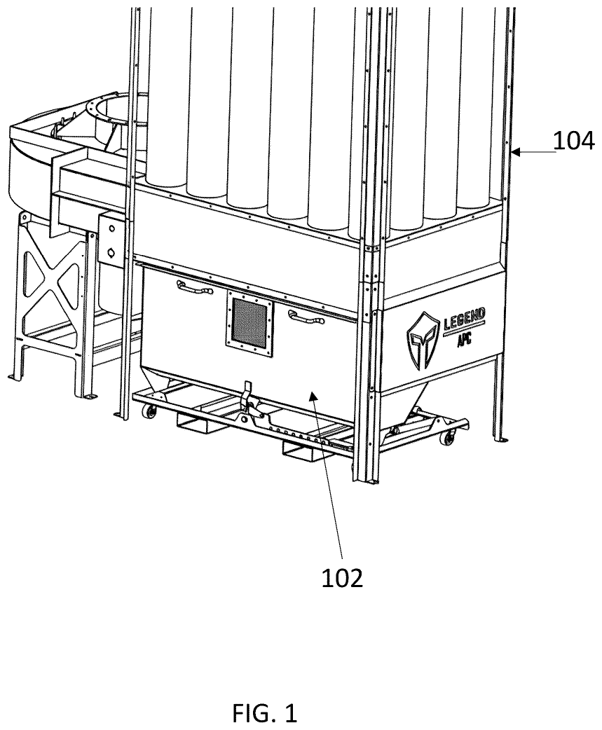

Referring to FIG. 1, a hopper assembly 102 is positioned underneath a debris collection system 104 in a manufacturing environment requiring debris capture. The debris collection system 104 includes a plurality of vertical filter media bags positioned above the hopper assembly 102. The hopper assembly 102 is positioned to receive debris released from the filter media bags during operation of the debris collection system 104.

The hopper assembly 102 includes a body with a plurality of panels forming an interior volume for receiving and containing debris. A window is positioned on one of the panels of the hopper assembly 102 to allow visual inspection of accumulated debris within the hopper assembly 102. The hopper assembly 102 is supported on a base assembly that includes a plurality of wheels for moving the hopper assembly 102 and fork tubes configured to receive forklift prongs for transportation. Handles on the hopper assembly 102 facilitate operator manipulation of the hopper assembly 102.

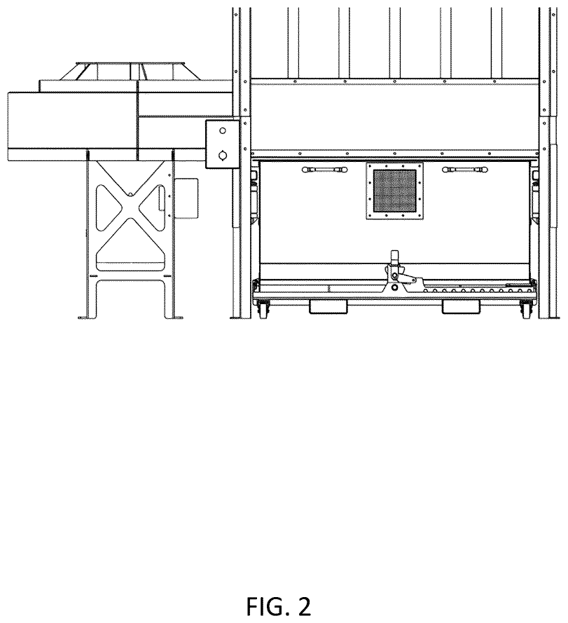

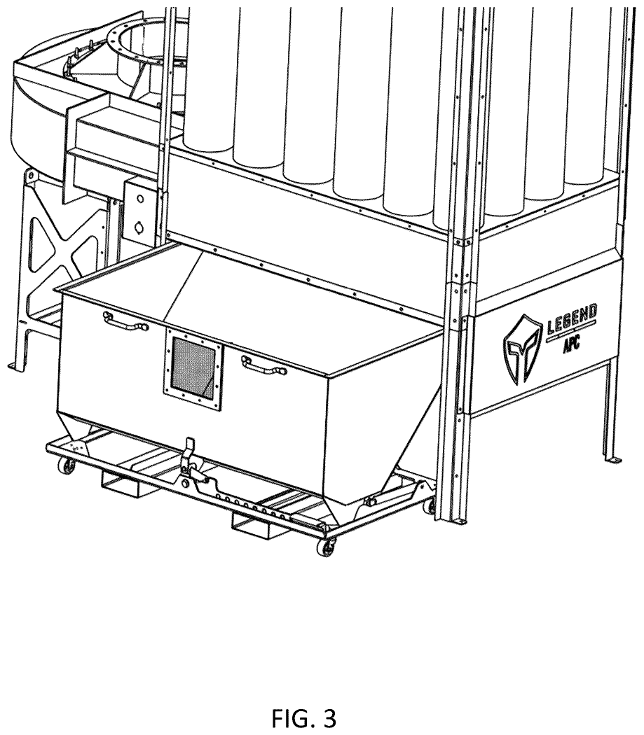

Referring to FIGS. 2-4, a positioning sequence of a hopper assembly is illustrated. The hopper assembly is positioned under a debris collection system. Once the hopper assembly is positioned beneath the debris collector, pneumatic actuators (e.g., levers) connected to the debris collection system create vacuum suction that lifts the hopper assembly into a sealed engagement with a bottom of the debris collection system. During debris collection operations, debris from filter media bags or similar components are received by the hopper assembly. After debris collection operations are performed, as illustrated in FIGS. 3 and 4, the hopper assembly is removed from the debris collection system for emptying operations. The hopper assembly can be transported using the wheels on the base assembly or forklift equipment engaging the fork tubes.

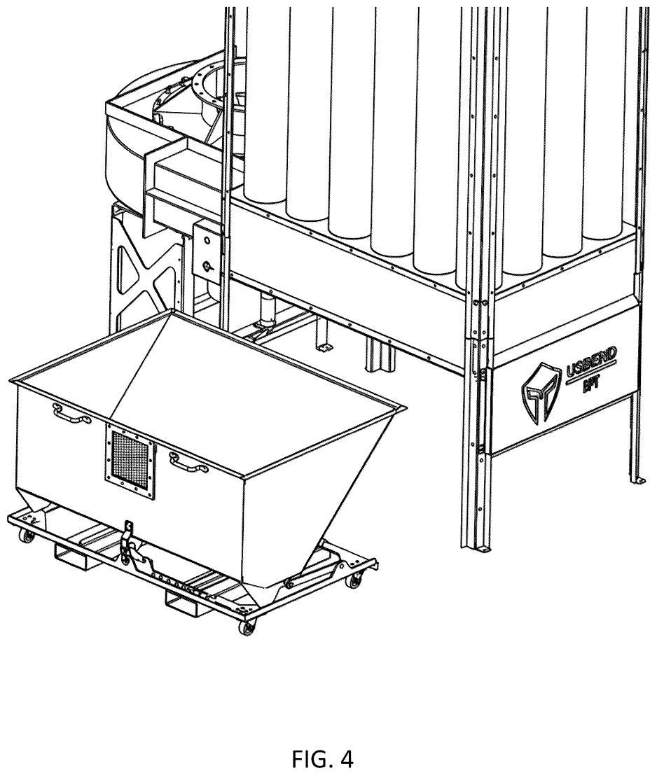

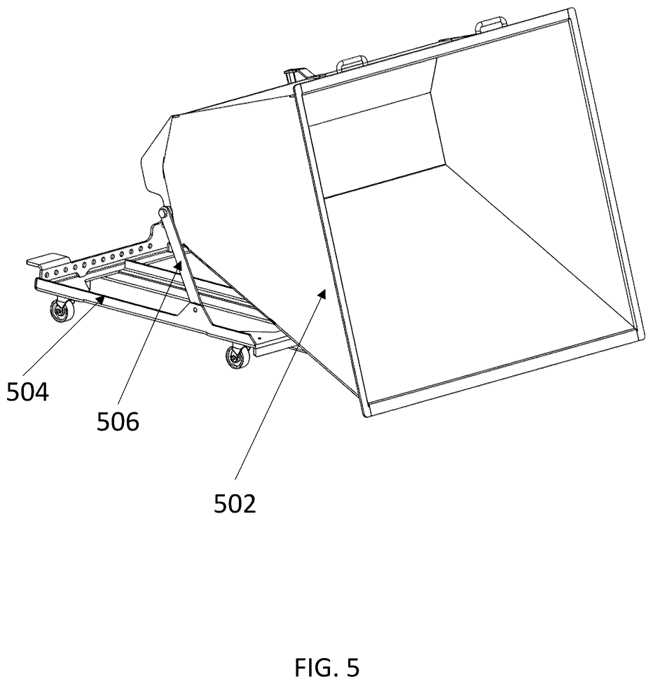

FIG. 5 illustrates a hopper assembly 502 in an emptying position. The hopper assembly 502 is pivotably connected to a base assembly 504 via at least one pivot arm 506. The pivot arm 506 enables the hopper assembly 502 to move between the upright position and the emptying position. In some aspects, the hopper assembly 502 includes at least two pivot arms connected by a pivot member (e.g., pivot rod) positioned underneath the interior volume of the hopper assembly 502. The hopper assembly 502 is configured to pivot relative to the pivot member. The hopper assembly 502 moves (e.g., pivots) forward and downward from the upright position, resulting in the release of accumulated debris from an interior volume of the hopper assembly 502. The base assembly 504 remains in a horizontal orientation during the emptying operation. After the emptying operation is complete, the hopper assembly 502 is configured for operators to position the hopper assembly 502 in the upright position. A latch mechanism secures the hopper assembly relative to the base assembly 504.

In some aspects, the hopper assembly is rotatably coupled to the base assembly via a pivoting assembly for emptying operations. The debris collection hopper system includes a pair of support arms (e.g., pivot arms) that extend upward from the base assembly to the hopper assembly. These support arms are connected by a pivot member (e.g., pivot rod) that provides an axis of rotation for the hopper assembly. The axis of rotation is substantially perpendicular to the vertical movement of the hopper assembly.

The hopper assembly is mounted or positioned over the pivot member. The hopper assembly includes a channel, slot, or similar member for rotatably engaging the pivot member. The rotation about the pivot member ensures that the interior of the hopper assembly faces downward. Advantageously this improves the release of collected debris in the hopper assembly by using gravity-assisted emptying.

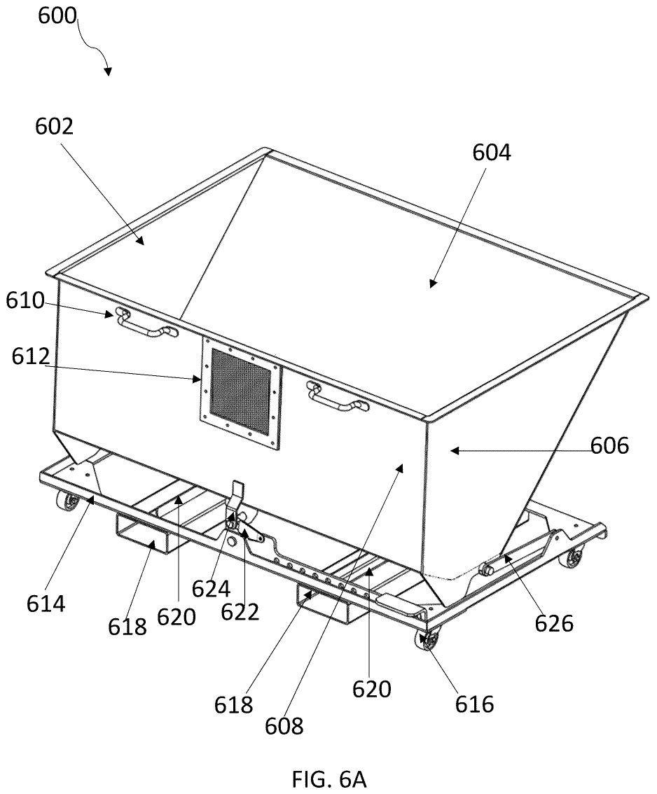

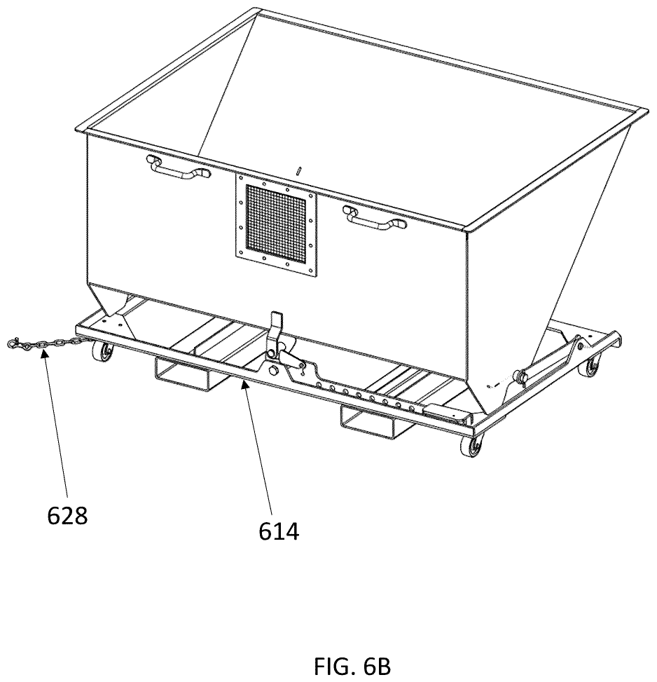

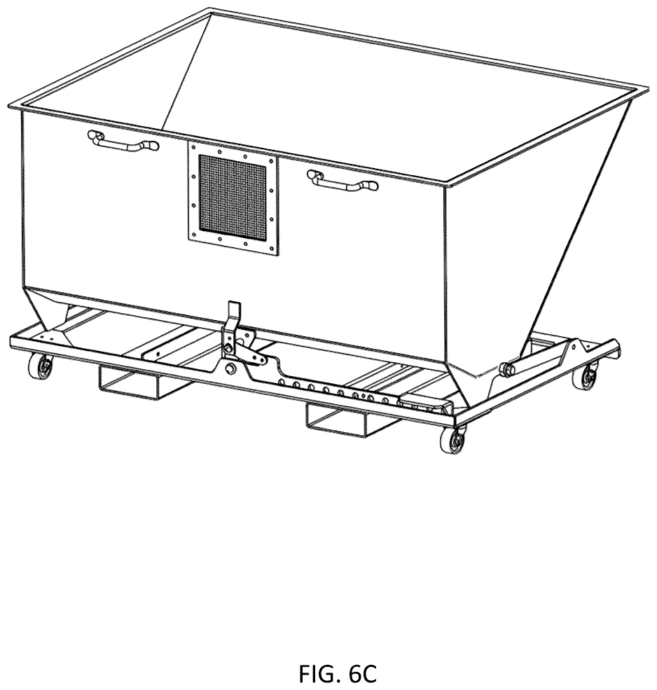

Referring to FIG. 6A, a debris collection hopper system 600 is illustrated. The debris collection hopper system 600 includes a hopper assembly with a body comprised of a plurality of panels defining an interior volume for receiving debris. The plurality of panels include a left-side panel 602, a front panel 604, a right-side panel 606, and a rear panel 608. The plurality of panels form a tapered shape with a wider upper opening and a narrower lower portion. The left-side panel 602, front panel 604, right-side panel 606, and rear panel 608 form the interior volume for receiving and holding debris released from a debris collection system.

The rear panel 608 includes handles 610 positioned near an upper region of the rear panel 608. The handles 610 are configured for manual manipulation of the debris collection hopper system 600, enabling operators to push or pull the debris collection hopper system 600 to reposition the debris collection hopper system 600 as needed during debris collection and emptying operations. The rear panel 608 includes a window 612 positioned below the handle 610. The window 612 is configured to allow visual inspection of debris accumulated within the interior volume of the hopper assembly. Advantageously, this enables operators to monitor the debris levels without opening or removing the debris collection hopper system 600 from a debris collection system.

The hopper assembly is supported by a base assembly 614. The base assembly 614 includes a plurality of wheels 616 coupled to a frame structure, enabling mobility of the debris collection hopper system 600 across floors. The base assembly 614 further includes a pair of fork tubes 618 configured to receive forklift prongs for transporting the debris collection hopper system.

The base assembly 614 includes rocker angle supports 620 positioned on the frame structure. The rocker angle supports 620 are configured to support rocker components and limit lateral shifting when the hopper assembly moves from the upright position to an emptying position. A latch 622 is positioned on the base assembly 614 and a latch bracket 624 is positioned on the hopper assembly. The latch 622 and the latch bracket 624 form a latch mechanism configured to secure the hopper assembly in the upright position relative to the base assembly 614. When the latch 622 engages the latch bracket 624, the hopper assembly is held in the upright position for debris collection. When the latch 622 is disengaged, the hopper assembly is configured to move (e.g., pivot) to the emptying position.

The debris collection hopper system 600 further includes a pivoting assembly 626. The pivoting assembly includes a pair of support arms (e.g., pivot arms) that extend upward from the base assembly 614 to the hopper assembly. These support arms are connected by a pivot member (e.g., pivot rod) that provides an axis of rotation for the hopper assembly. The axis of rotation is substantially perpendicular to the vertical movement of the hopper assembly.

Referring to FIG. 6B, a chain 628 extends from the base assembly 614 and is configured to attach to a forklift or similar anchoring point to prevent the base assembly 614 from tipping during emptying operations. FIG. 6C illustrates a perspective view of a hopper assembly in an upright position according to aspects of the present disclosure.

FIG. 7 illustrates a bottom perspective view of a debris collection hopper system according to aspects of the present disclosure. The debris collection hopper system includes a plurality of rockers 702 positioned on a front panel of the hopper assembly. The rockers 702 are curved structural components for facilitating the pivoting of the hopper assembly during emptying operations. In some aspects, the engagement between the rockers 702 and rocker supports of the base assembly provide a control pivot path for the hopper assembly.

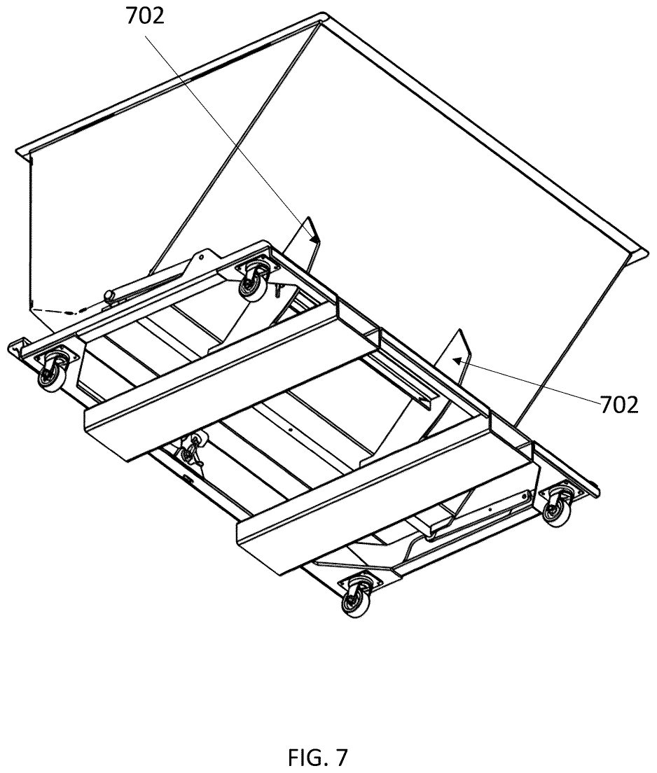

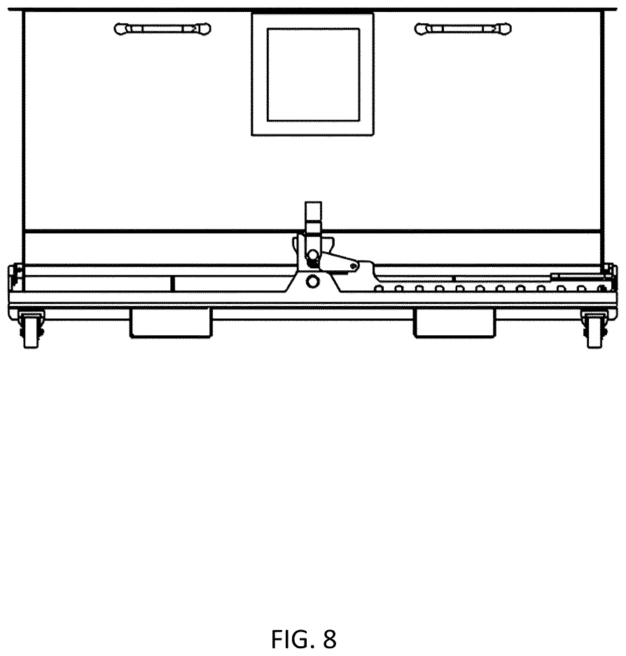

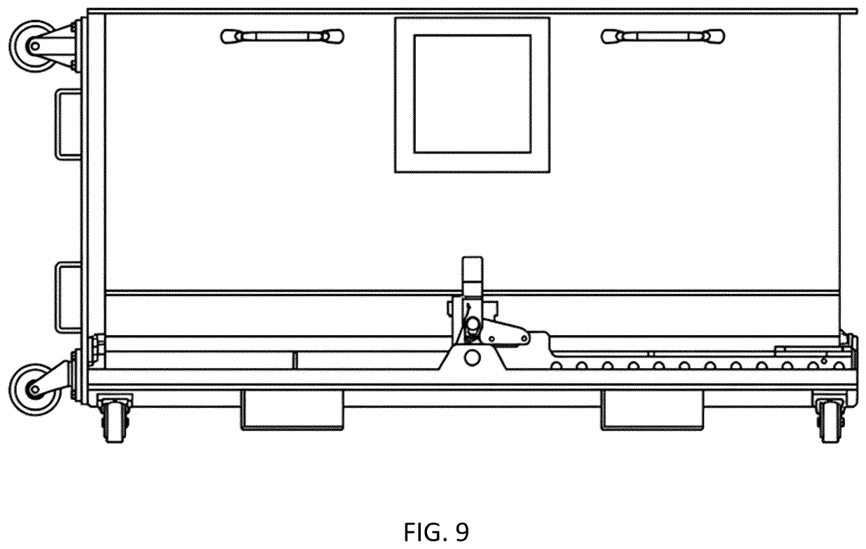

FIGS. 8-9 illustrate rear view of a debris collection hopper system according to aspects of the present disclosure. The window positioned near an upper portion of the rear panel enables visual inspection of accumulated debris within the interior volume of the hopper assembly. A pair of handles positioned on the rear panel enables operator manipulation of the debris collection hopper system. The hopper assembly is releasably attached to a base assembly via a latch mechanism positioned near a bottom of the rear panel. The hopper assembly is pivotably connected to a base assembly via a pivot assembly. The pivot assembly enables the hopper assembly to move relative to the base assembly during the transition between the upright position and the emptying position.

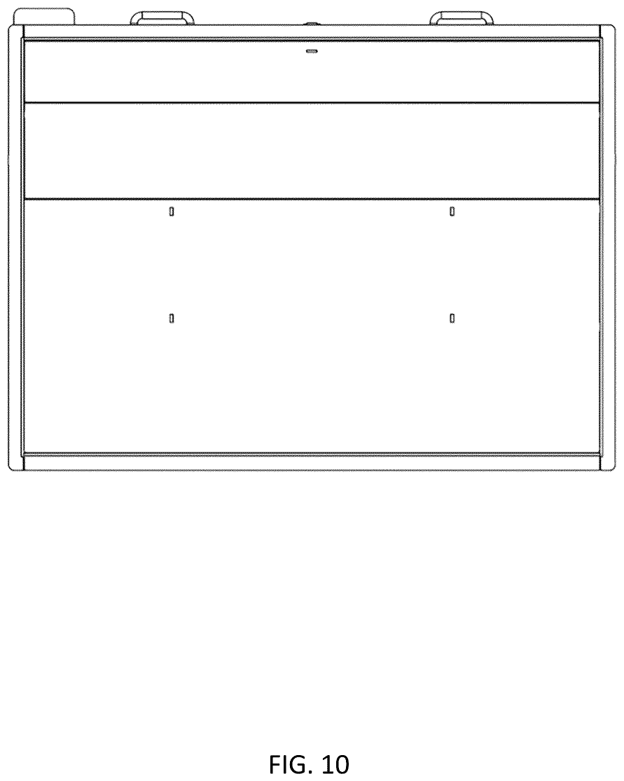

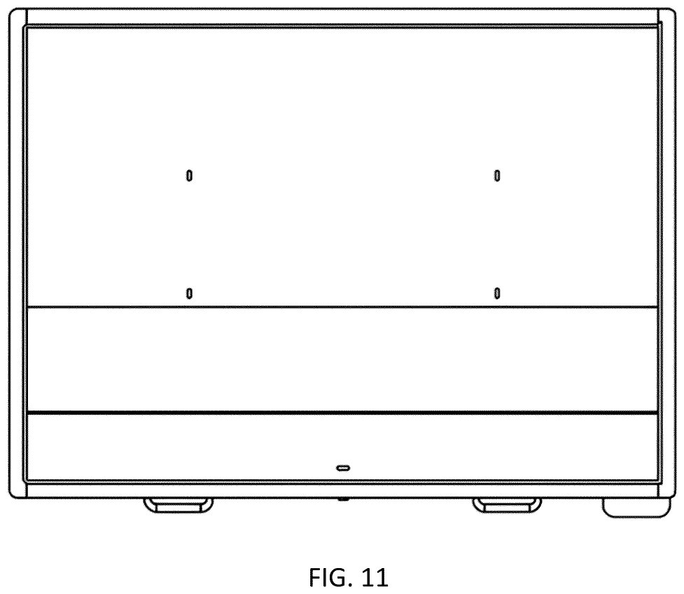

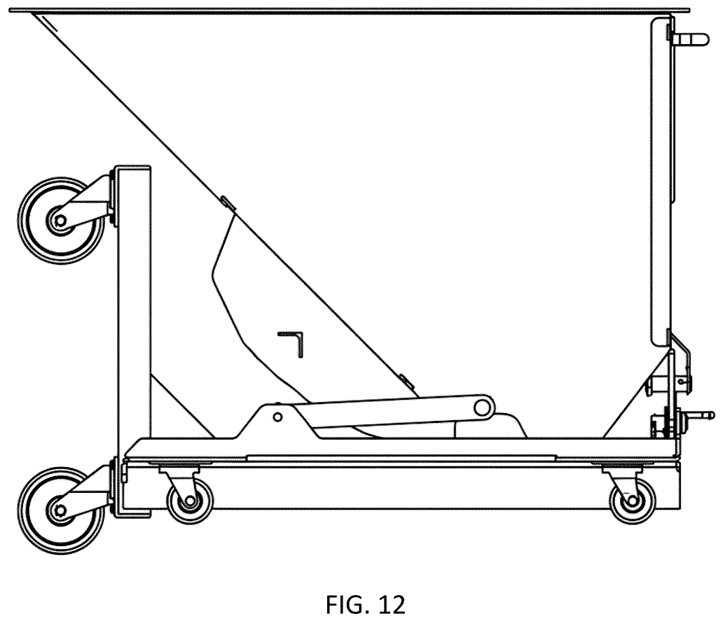

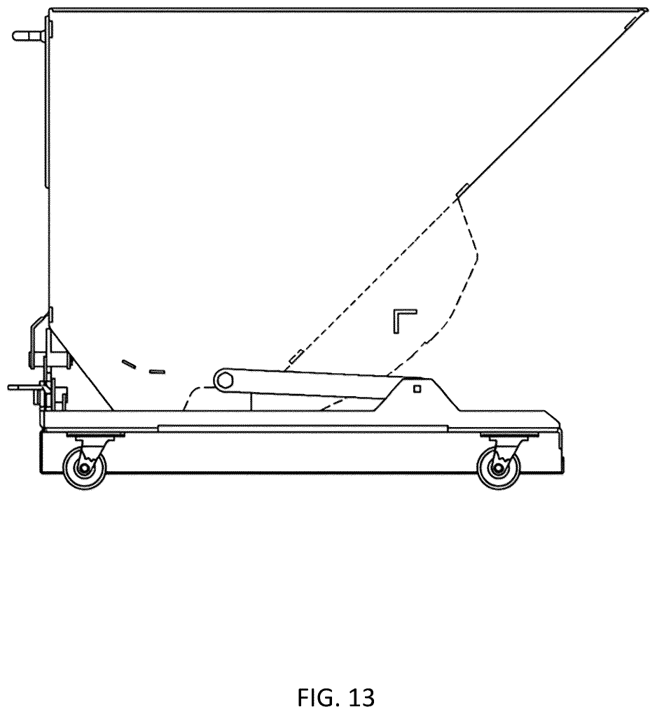

FIGS. 10-11 illustrate top views of a debris collection hopper system according to aspects of the present disclosure. The debris collection hopper system includes a hopper assembly. The hopper assembly includes a body formed by a plurality of panels that define an interior volume for receiving and containing debris. FIGS. 12-13 illustrates side views of a debris collection hopper system according to aspects of the present disclosure.

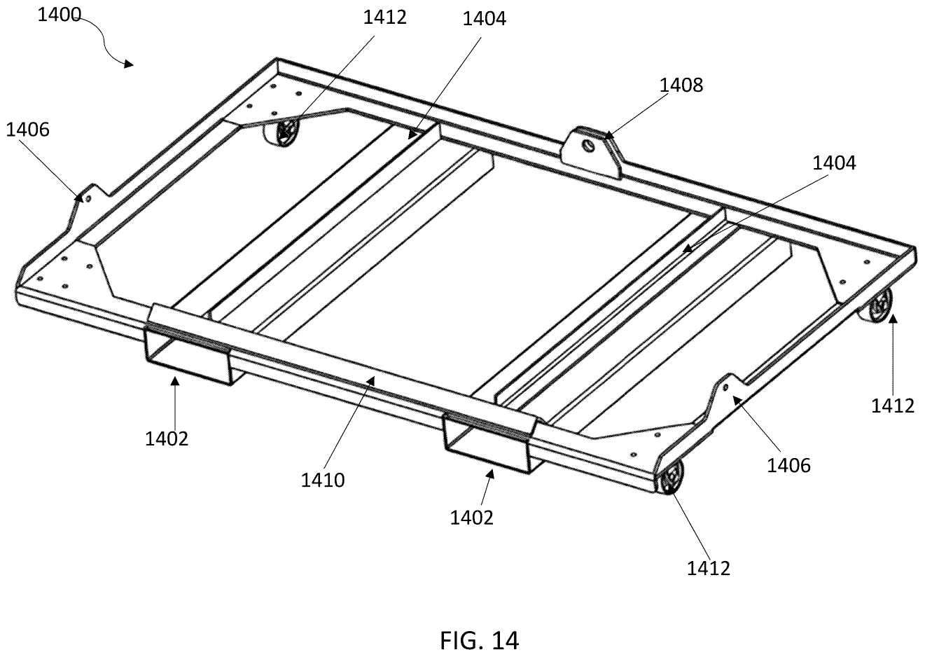

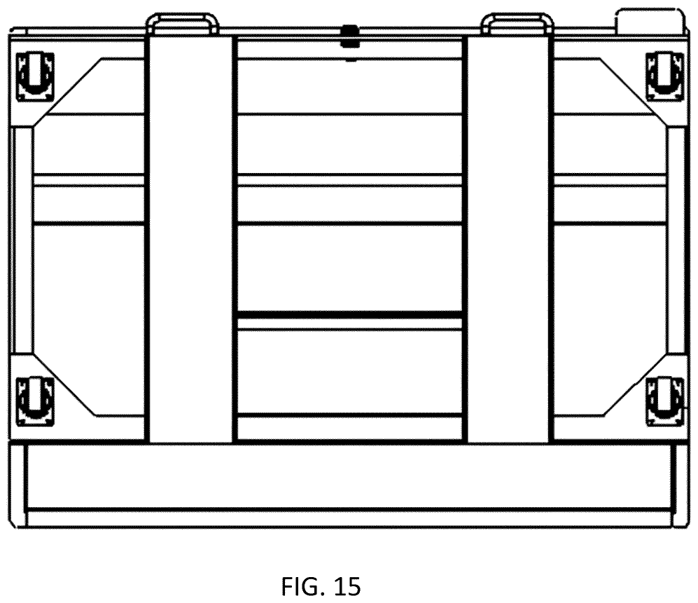

FIG. 14 is a perspective view of a base assembly according to aspects of the present disclosure. The base assembly 1400 includes a rectangular frame structure that define the perimeter of the base assembly. The base assembly 1400 includes a pair of parallel fork tubes 1402, rocker angle supports 1404, pivot connection brackets 1406, a latch gusset 1408, a base stop 1410, and a plurality of wheels 1412. The pair of parallel fork tubes 1402 are configured to receive forklift prongs for transportation of the debris collection hopper system. The rocker angle supports 1404 interface with rocker components of the hopper assembly during pivoting operations. The pivot connection brackets 1406 receive a pivot arm or similar component for pivotably connecting the base assembly 1400 to a hopper assembly. The latch gusset 1408 provides structural support for a latching mechanism of a debris collection hopper system. The base stop 1410 aligns a corresponding hopper assembly with the base assembly 1400. The plurality of wheels 1412 enable movement of the base assembly as needed in manufacturing or industrial environments. FIG. 15 illustrates a bottom view of a debris collection hopper system according to aspects of the present disclosure.

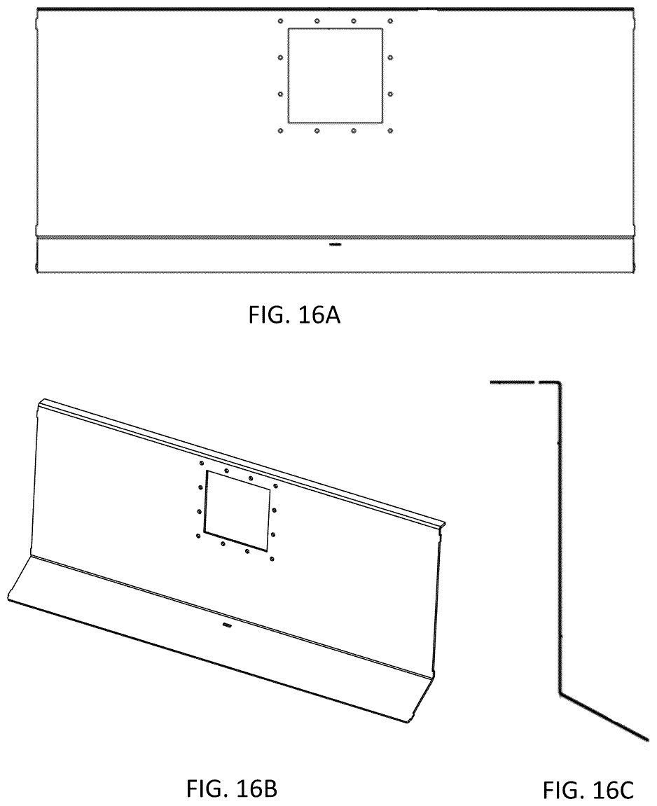

FIGS. 16A-16C illustrate a rear panel of a hopper assembly. In some aspects, the rear panel has a rectangular cutout region for receiving a window that enables visual inspection of the interior volume of the hopper assembly. A plurality of holes around the rectangular cutout region are configured to receive fasteners for attaching the window and a corresponding frame. The rear panel includes a bent configuration that enables the rear panel to form part of the tapered shape of the hopper assembly interior volume while providing an upper edge including a lip for attaching to a debris collector.

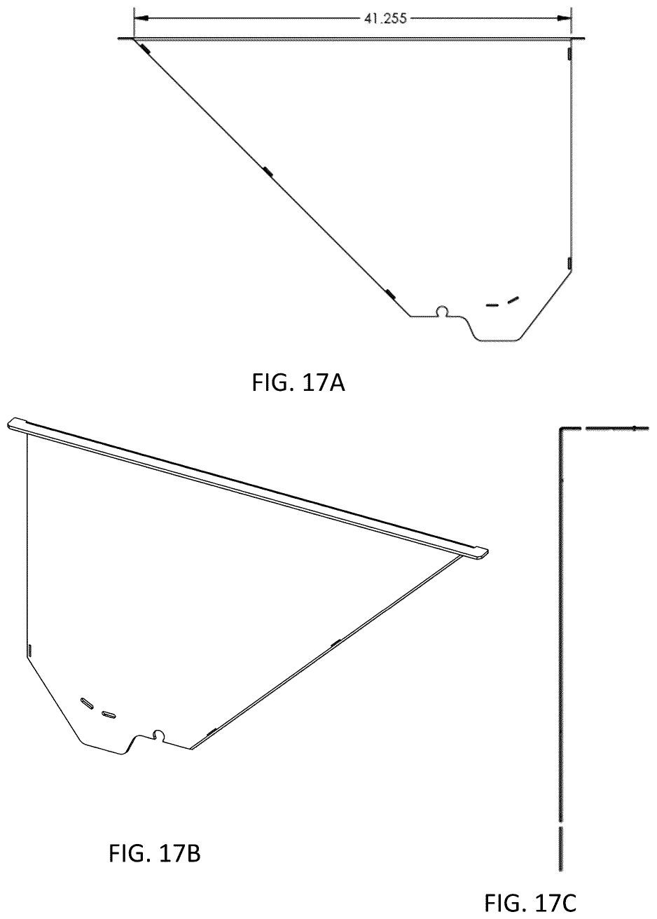

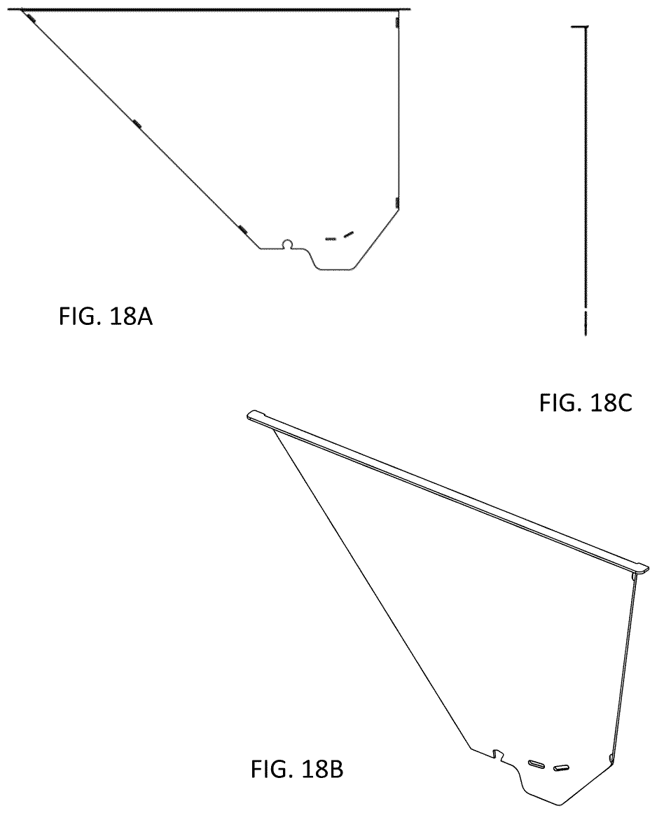

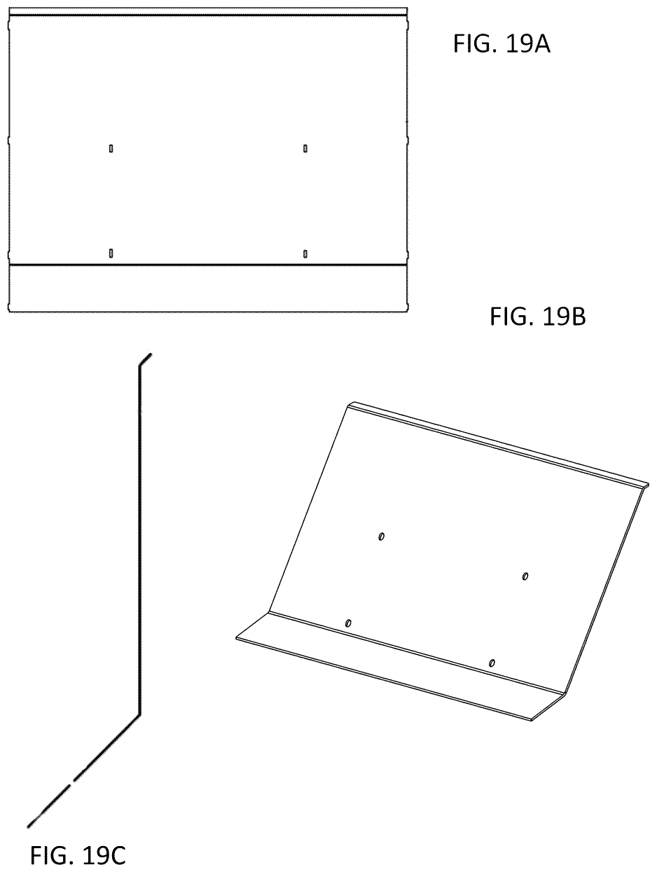

FIGS. 17A-17C illustrate a left-side panel of a hopper assembly. The left-side panel includes a tapered shape with an upper edge including a lip. FIGS. 18A-18C illustrate a right-side panel of a hopper assembly. The right-side panel includes a tapered shape with an upper edge including a lip. FIGS. 19A-19C illustrate a front panel of a hopper assembly. The left-side panel, the right-side panel, the front panel, and the rear panel may include polycarbonate or similar materials. Each side panel is configured to attach to the front panel and the rear panel to form the interior volume of the hopper assembly.

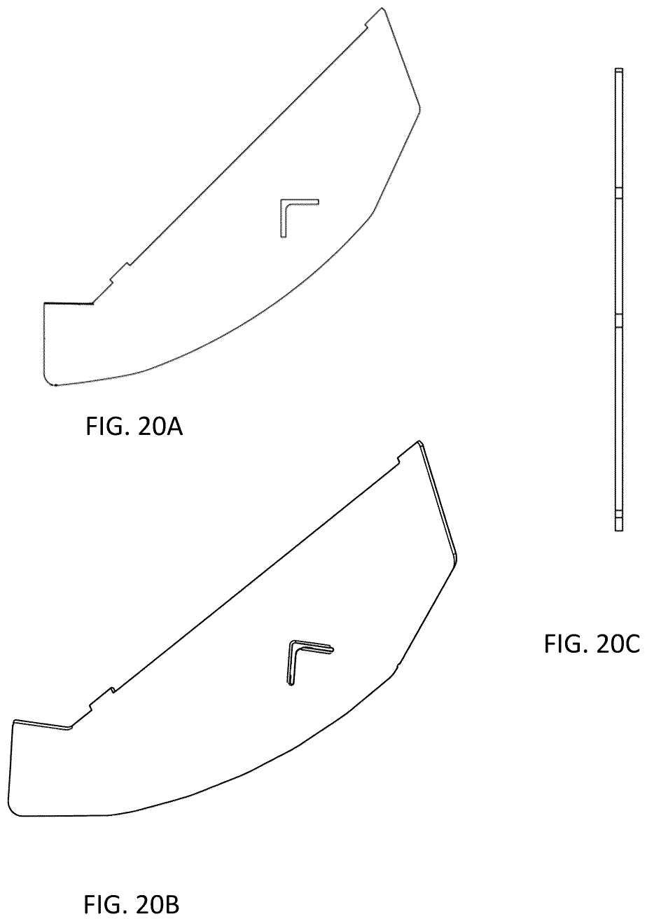

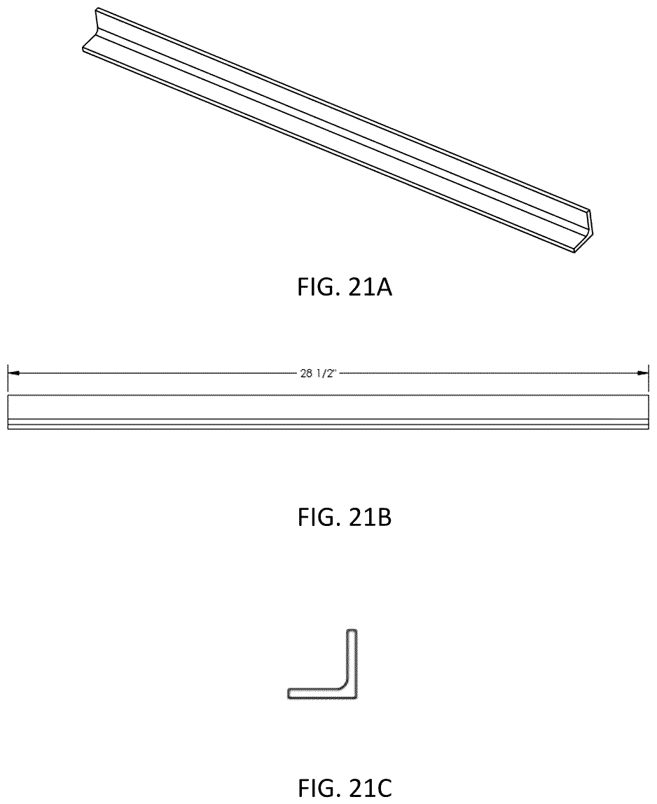

FIGS. 20A-20C illustrate a rocker of a hopper assembly according to aspects of the present disclosure. The curved contour of the rocker facilitates a pivoting motion as the hopper assembly transitions between the upright position and the emptying position. FIGS. 21A-21C illustrate a rocker support angle according to aspects of the present disclosure. The rocker support angle is configured to be mounted on the base assembly to support the rocker and prevent lateral shifting of the rocker during pivoting operations of the hopper assembly.

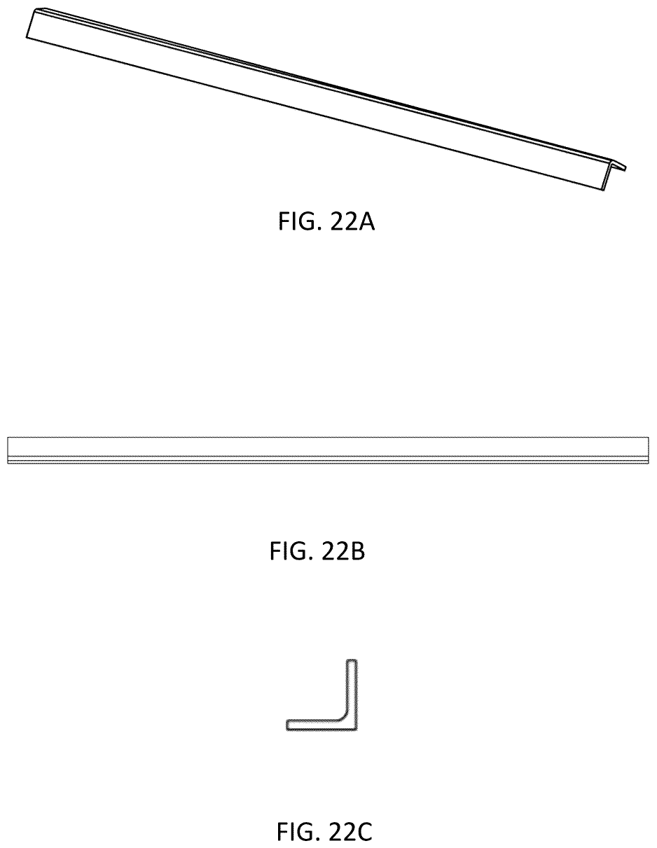

Referring to FIGS. 22A-22C, a base stop of a hopper assembly is illustrated. The base stop is an elongated structural member having an L-shaped cross-sectional profile. The base stop includes a horizontal flange portion and a vertical flange portion. The base stop is configured to function as a structural support element within the debris collection hopper system, providing a stop surface that limits movement or positioning of the hopper assembly.

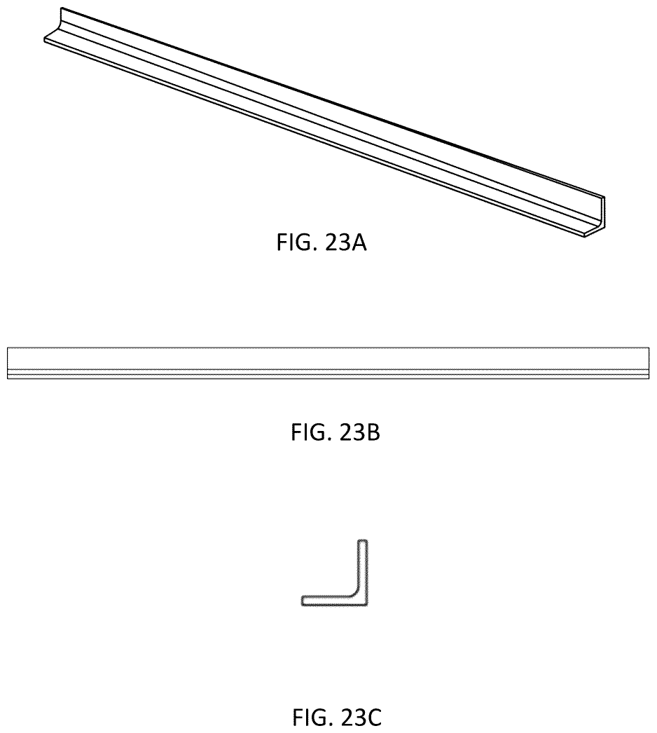

FIGS. 23A-23C illustrate a hopper base rocker angle according to aspects of the present disclosure. The hopper base rocker angle is an elongated L-shaped structural member. The hopper base rocker angle is configured to interface with the rocker components of the hopper assembly and provides structural support during the pivoting operation when the hopper assembly transitions between the upright position and the tilted emptying position.

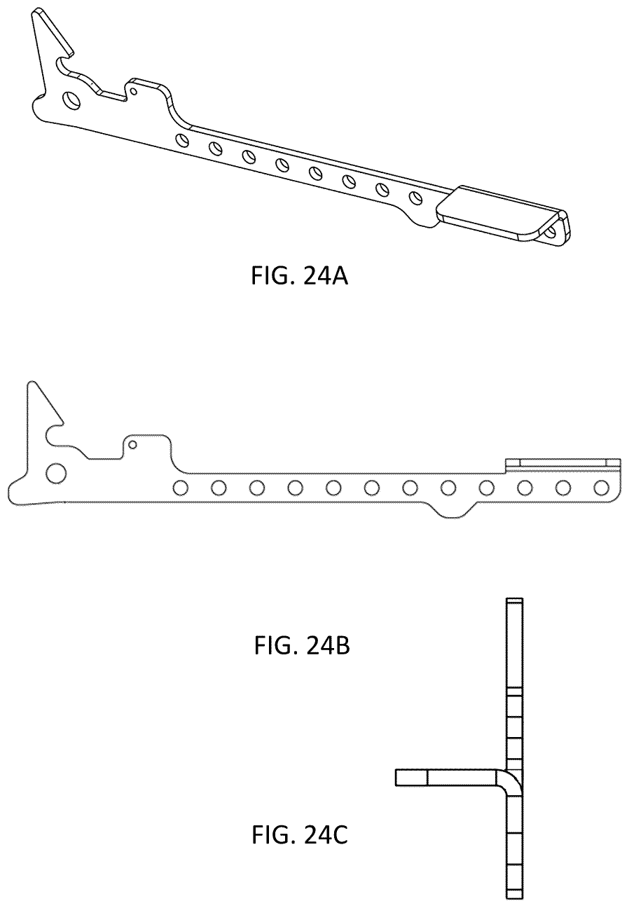

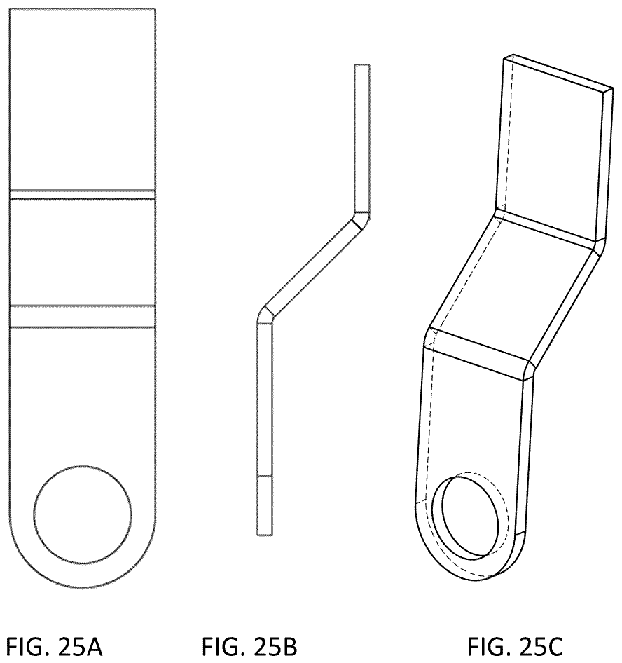

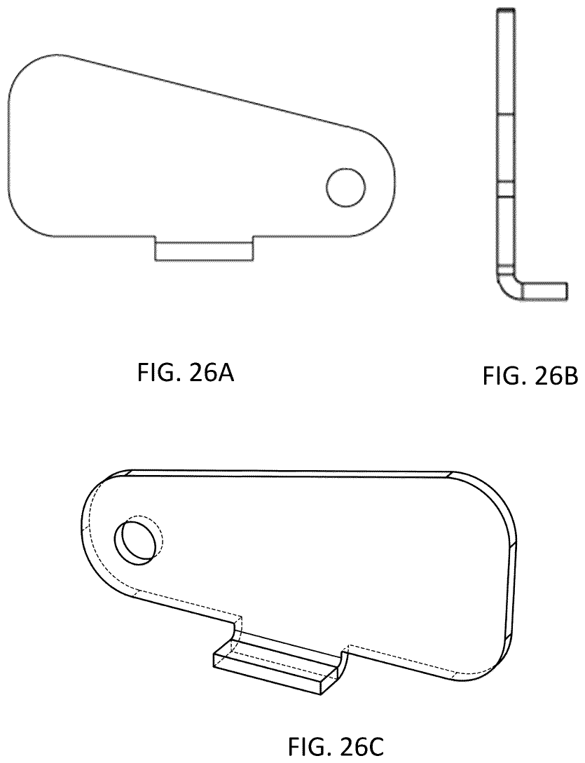

Referring to FIGS. 24A-24C, the latch arm is an elongated component configured to secure the hopper assembly in the upright position relative to the base assembly. The latch arm includes a mounting end portion with an angled profile and mounting holes for attachment to the hopper assembly. The mounting end features a raised tab or hook element configured to engage with corresponding components of the latch mechanism. Referring to FIGS. 25A-25C, the latch bracket is an elongated flat member with a rounded end portion. The latch bracket includes a circular aperture positioned within the rounded end portion; the circular aperture being configured to receive a fastener or pivot pin for connection to other components of the hopper assembly. FIGS. 26A-26C illustrates a latch arm safety latch according to aspects of the present disclosure. The latch arm safety latch is configured to prevent unintended release of the latch arm, thereby securing the hopper assembly in the upright position relative to the base assembly during operation of the debris collection hopper system.

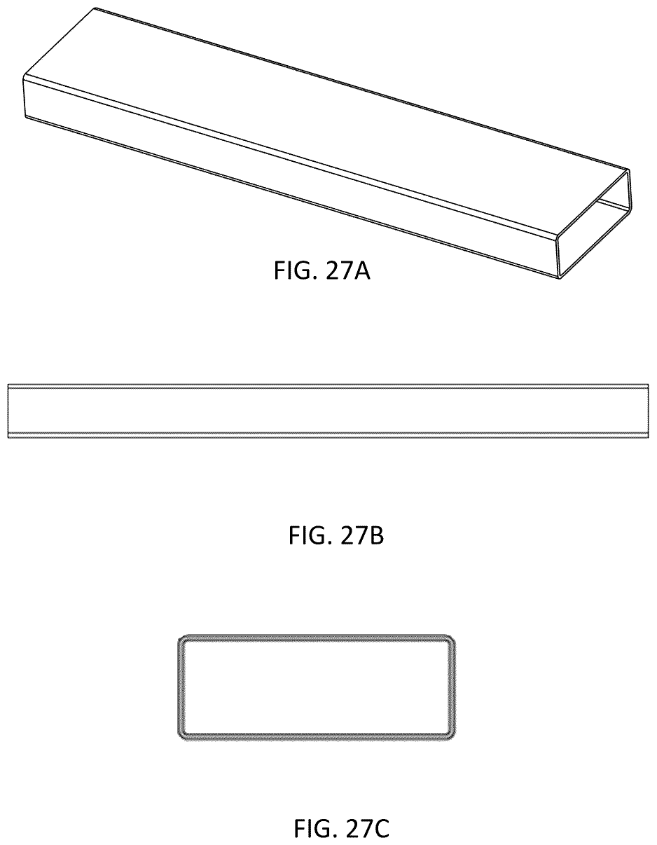

Referring to FIGS. 27A-27C, the fork tube is a rectangular tubular member with an elongated profile configured to receive forklift prongs for transport of the debris collection hopper system. The fork tube has a hollow rectangular cross-section with walls forming an enclosed channel. The hollow interior of the fork tube is sized to accommodate forklift prongs, enabling operators to lift and transport the debris collection hopper system using forklift equipment. The rectangular tubular construction provides structural support while maintaining the hollow interior for forklift tine engagement. A pair of fork tubes is positioned on the base assembly to enable lifting and transport of the debris collection hopper system.

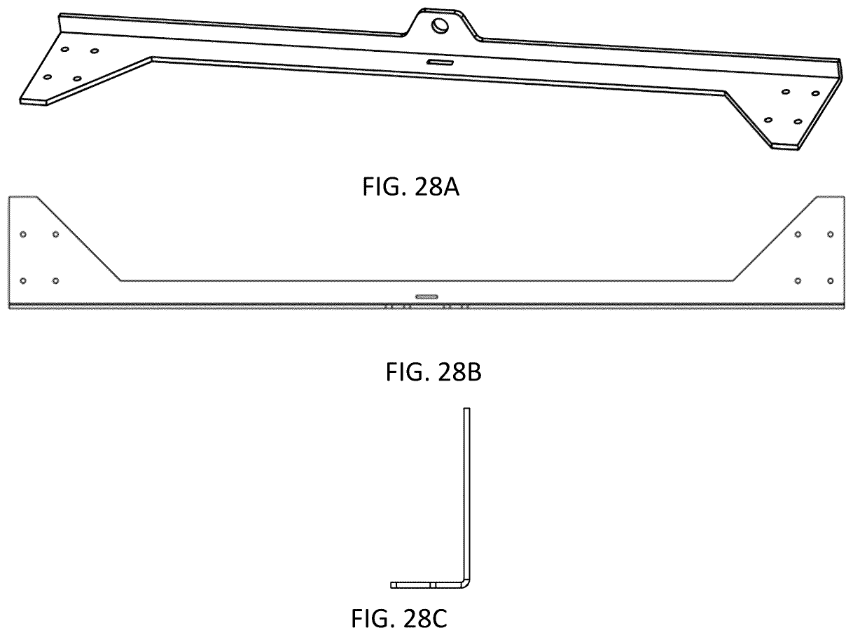

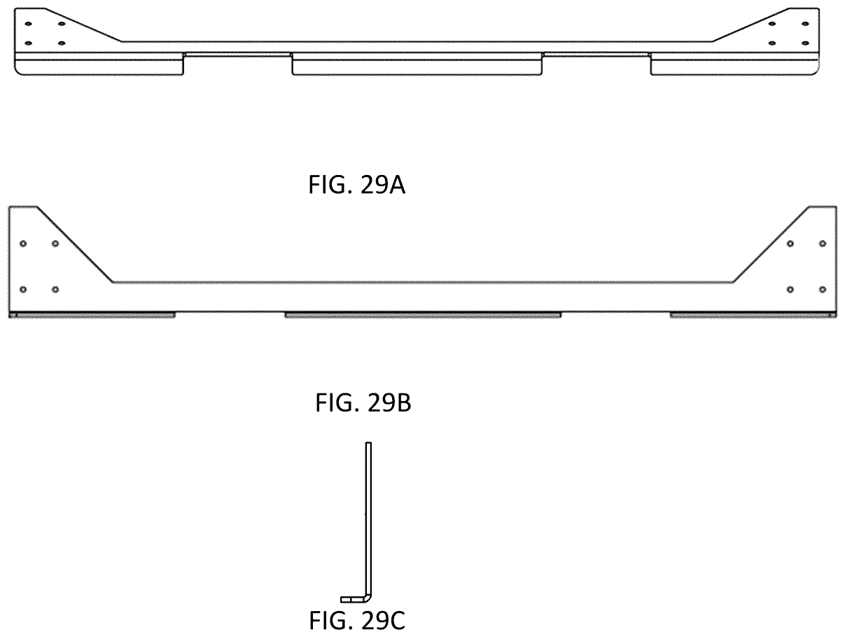

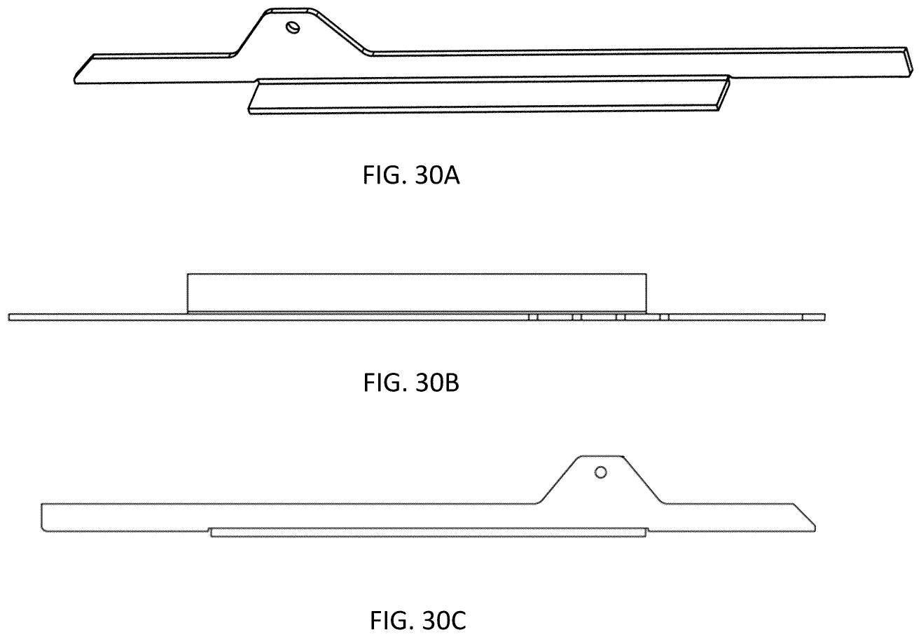

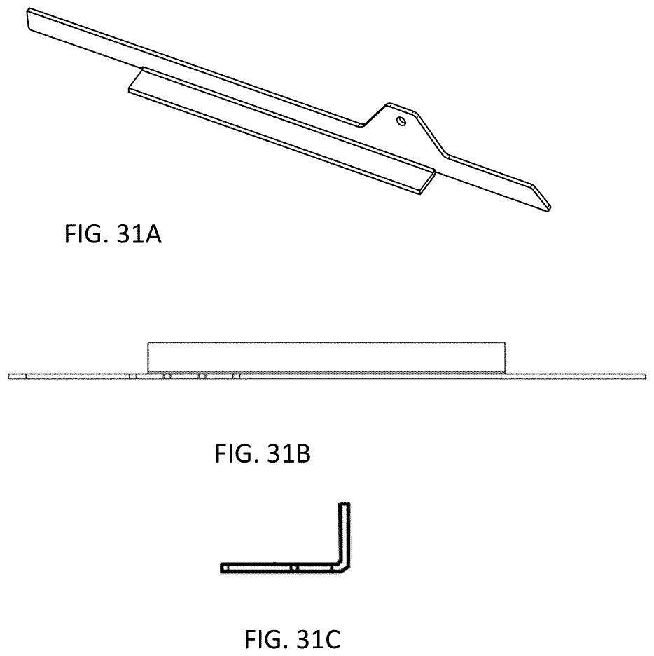

FIGS. 28A-28C illustrate a rear frame component of a base assembly. FIGS. 29A-29C illustrate a front component of a base assembly according to aspects of the present disclosure. FIGS. 30A-30C illustrate a right frame component of a base assembly. FIGS. 31A-31C illustrate a left-frame component of a base assembly.

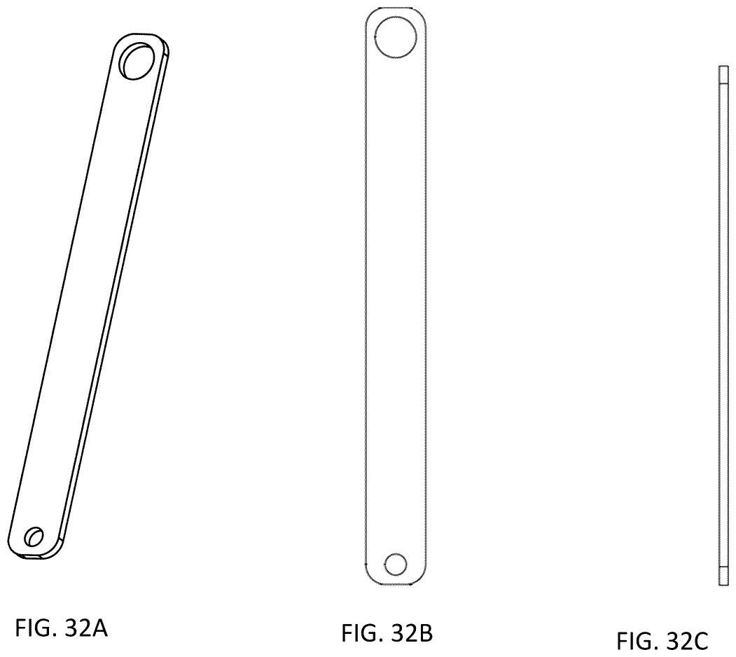

Referring to FIGS. 32A-32C, a pivot arm of a debris collection hopper system is illustrated. The pivot arm is an elongated flat bar with rounded ends. FIG. 32A provides a perspective view of the pivot arm showing the elongated configuration with the rounded end portions at each end of the pivot arm. FIG. 32B illustrates a planar view of the pivot arm showing the full length of the elongated bar and the positioning of circular apertures at each end. FIG. 32C illustrates an end view of the pivot arm showing the rectangular cross-sectional profile of the component. Each rounded end of the pivot arm includes a circular aperture extending through the thickness of the pivot arm. The circular apertures are configured to receive fasteners or pivot pins that connect the pivot arm between the hopper assembly and the base assembly. The pivot arm enables the hopper assembly to rotate relative to the base assembly between the upright position and the emptying position.

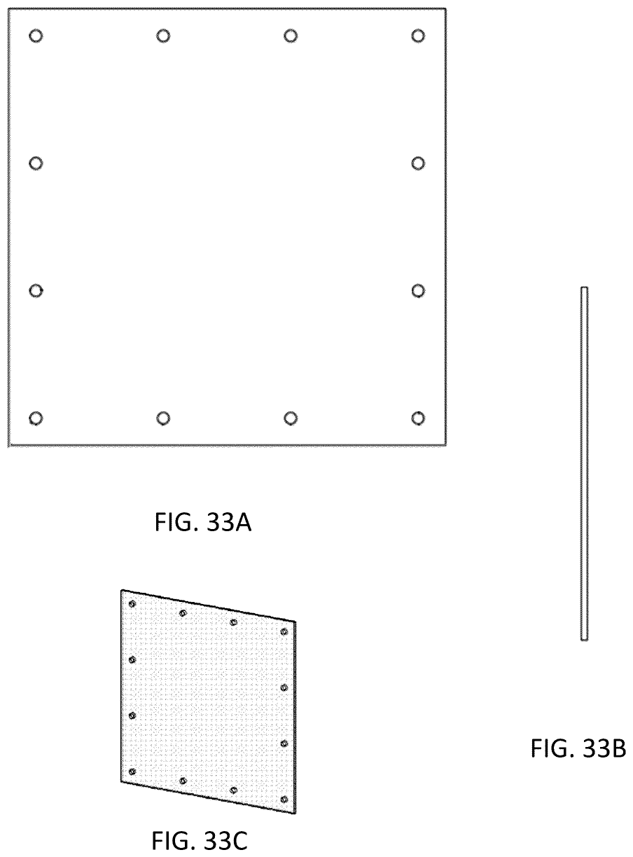

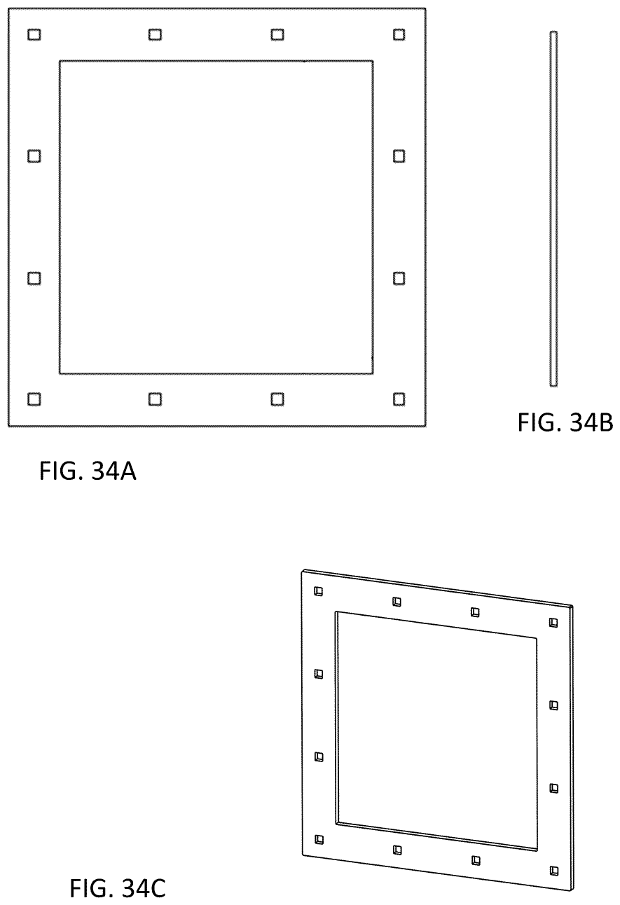

Referring to FIGS. 33A-33C, the window is a flat rectangular panel formed from a transparent material such as polycarbonate. FIG. 33A illustrates a planar view of the window, FIG. 33B illustrates an end view of the window, and FIG. 33C illustrates a perspective view of the window. The window is configured to be mounted within a window frame on the rear panel of the hopper assembly, allowing visual inspection of debris accumulated within the interior volume of the hopper assembly. FIGS. 34A-34C illustrate a window frame according to aspects of the present disclosure. FIG. 34A illustrates a planar view of the window frame. FIG. 34B illustrates an end view of the window frame, and FIG. 34C illustrates a perspective view of the window frame. The window frame is configured to mount the polycarbonate window panel to the rear panel of the hopper assembly, enabling visual inspection of debris accumulated within the interior volume of the hopper assembly.

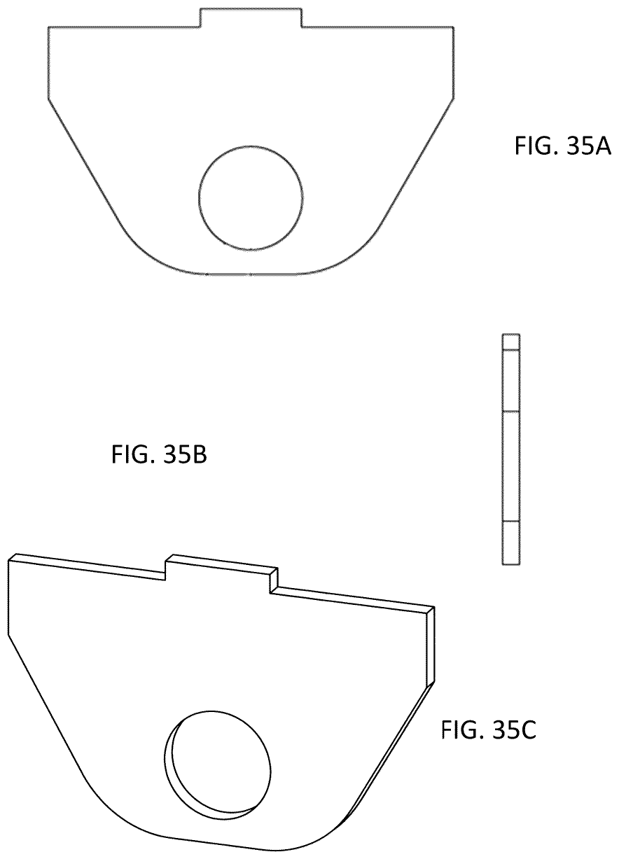

Referring to FIGS. 35A-35C, the latch bracket gusset is a structural component configured to provide reinforcement to the latch bracket assembly of the hopper system. FIG. 35A depicts a planar front view of the latch bracket gusset, showing a generally trapezoidal component with a rounded bottom edge. FIG. 35B depicts an end view of the latch bracket gusset. FIG. 35C illustrates a perspective view of the latch bracket gusset.

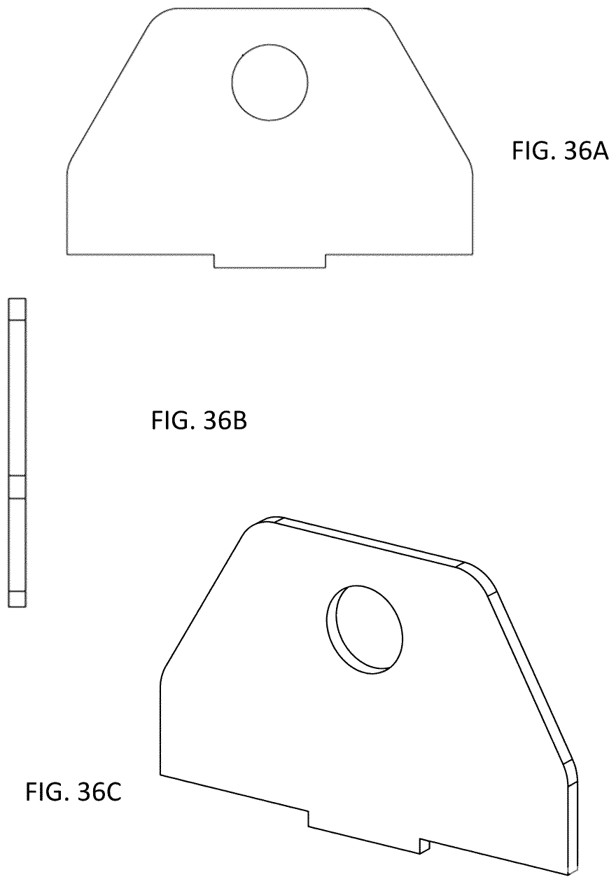

Referring to FIGS. 36A-36C, the base pivot gusset is a structural component configured to function as a reinforcing element at a pivot connection point between the hopper assembly and the base assembly. FIG. 36A provides a planar view of the base pivot gusset, FIG. 36B provides an end view of the base pivot gusset, and FIG. 36C provides a perspective view of the base pivot gusset.

In some embodiments, a debris collection hopper system is disclosed. The debris collection hopper system includes a hopper and a support assembly. In some embodiments, the support assembly includes an actuator (e.g., electric, pneumatic). The debris collection hopper system includes a plurality of angled supports to align the hopper under a debris (e.g., dust) collector. In some embodiments, the debris collector includes a plurality of filter media bags. In the aligned position, the hopper is positioned to receive debris from the filter media bags and other debris collector dropouts. The support assembly is positioned (e.g., mounted) on top of at least one of the plurality of angled supports. The support assembly includes a plurality of cylinders to lift the hopper. For example, and without limitation, the cylinders push a beam fitted against a top of the cylinders. As a result, the beam presses against a lip of the hopper. In some embodiments, the beam provides a uniform pressure force to the lip of the hopper. As a result, the hopper is lifted until the hopper contacts a bottom of the dust collector to create a sealed environment.

In some embodiments, the hopper includes a plurality of handles designed for pulling and/or pushing the hopper. Advantageously, the hopper is easily transported, enabling operators to swap a first hopper for a second hopper during operation of a debris collection system. In some embodiments, the hopper includes a plurality of support members operable to receive forklift prongs. Advantageously, this enables operators to use a forklift to transport the hopper.

In some embodiments, the hopper includes at least one handle designed for operating a door at a bottom of the hopper. For example, and without limitation, the door is a guillotine-style door. The handle is operable to move between a folded position and an unfolded position. In the folded position, the handle can reside against and/or underneath the hopper, thereby keeping the handle out of an operator's path. The positioning of the handle controls the positioning of the door. For example, and without limitation, in some embodiments, as the handle extends away from the body of the hopper, the handle pulls the door away from the bottom of the hopper, thereby allowing debris to exit the hopper. In some embodiments, the handle is attached to the hopper via a spring clip.

In some embodiments, the debris collection hopper system includes a control panel. The control panel is operable to control the operation of the pneumatic support assembly. For example, and without limitation, the control panel includes a power button and a stop button. The power button is operable to activate the pneumatic support assembly to lift or lower a hopper. The stop button is operable to pause or cancel the activation of the pneumatic support assembly. In some embodiments, the control panel includes a visual indicator. The visual indicator is operable to indicate a status of the pneumatic support assembly. For example, and without limitation, the status of the pneumatic support assembly includes a (1) activation status and (2) a sealed status. The activation status indicates whether the pneumatic support assembly is lifting or lowering a hopper. The sealed status indicates whether a hopper is securely connected to a debris collector.

The corresponding structures, materials, acts, and equivalents of all means or step plus function elements in the claims below are intended to include any structure, material, or act for performing the function in combination with other claimed elements as specifically claimed.

Particular embodiments and features have been described with reference to the drawings. It is to be understood that these descriptions are not limited to any single embodiment or any particular set of features, and that similar embodiments and features may arise, or modifications and additions may be made without departing from the scope of these descriptions and the spirit of the appended claims.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

What is claimed is:

1. A debris collection hopper system comprising:
a hopper assembly for receiving debris;
a base assembly; and
a pivot assembly;
wherein the hopper assembly is rotatably connected to the base assembly via the pivot assembly; and
wherein the hopper assembly is configured to move between an upright position and an emptying position via the pivot assembly, wherein, when moving from the upright position to the emptying position, the hopper assembly is configured to move vertically and horizontally relative to the base assembly.

2. The debris collection hopper system of claim 1, wherein the pivot assembly comprises a first pivot arm, a second pivot arm, and a pivot rod, wherein the first pivot arm and the second pivot arm are on opposite sides of the hopper assembly, wherein the pivot rod connects the first pivot arm and the second pivot arm.

3. The debris collection hopper system of claim 2, wherein the hopper assembly is configured to pivot about the pivot rod when moving from the upright position to the emptying position.

4. The debris collection hopper system of claim 1 further comprising a latching mechanism, wherein the hopper assembly is releasably attached to the base assembly via the latching mechanism.

5. The debris collection hopper system of claim 4, wherein the hopper assembly is configured to move from the upright position to emptying position when the latching mechanism is released.

6. The debris collection hopper system of claim 4, wherein the latching mechanism includes a latch arm and a latch bracket, wherein the latch arm is configured to engage the latch bracket to secure the hopper assembly in the upright position.

7. The debris collection hopper system of claim 1, wherein the base assembly comprises a plurality of wheels and a plurality of fork tubes, wherein each fork tube of the plurality of fork tubes is configured to receive a fork of a forklift.

8. The debris collection hopper system of claim 1, wherein the hopper assembly comprises a plurality of panels forming an interior volume for receiving debris.

9. A debris collection hopper system comprising:
a hopper assembly;
a base assembly; and
a pivot assembly;
wherein the hopper assembly includes a plurality of panels forming an interior volume with an open top for receiving debris;
wherein the hopper assembly is rotatably connected to the base assembly via the pivot assembly; and
wherein the hopper assembly is configured to move between an upright position and an emptying position via the pivot assembly, wherein, when moving from the upright position to the emptying position, the hopper assembly is configured to move vertically and horizontally relative to the base assembly.

10. The debris collection hopper system of claim 9, wherein the pivot assembly comprises a first pivot arm, a second pivot arm, and a pivot rod, wherein the first pivot arm and the second pivot arm are on opposite sides of the hopper assembly, wherein the pivot rod connects the first pivot arm and the second pivot arm.

11. The debris collection hopper system of claim 10, wherein the hopper assembly is configured to pivot about the pivot rod when moving from the upright position to the emptying position.

12. The debris collection hopper system of claim 9 further comprising a latching mechanism, wherein the hopper assembly is releasably attached to the base assembly via the latching mechanism.

13. The debris collection hopper system of claim 12, wherein the hopper assembly is configured to move from the upright position to emptying position when the latching mechanism is released.

14. The debris collection hopper system of claim 12, wherein the latching mechanism includes a latch arm and a latch bracket, wherein the latch arm is configured to engage the latch bracket to secure the hopper assembly in the upright position.

15. The debris collection hopper system of claim 9, wherein the base assembly comprises a plurality of wheels and a plurality of fork tubes, wherein each fork tube of the plurality of fork tubes is configured to receive a fork of a forklift.

16. A debris collection hopper system comprising:
a hopper assembly;
a base assembly;
a pivot assembly; and
a latching mechanism;
wherein the hopper assembly includes a plurality of panels forming an interior volume with an open top for receiving debris;
wherein the hopper assembly is releasably attached to the base assembly via the latching mechanism, wherein the hopper assembly is rotatably connected to the base assembly via the pivot assembly;
wherein the hopper assembly is configured to move between an upright position and an emptying position via the pivot assembly, wherein, when moving from the upright position to the emptying position, the hopper assembly is configured to move vertically and horizontally relative to the base assembly.

17. The debris collection hopper system of claim 16, wherein the pivot assembly comprises a first pivot arm, a second pivot arm, and a pivot rod, wherein the first pivot arm and the second pivot arm are on opposite sides of the hopper assembly, wherein the pivot rod connects the first pivot arm and the second pivot arm.

18. The debris collection hopper system of claim 17, wherein the hopper assembly is configured to pivot about the pivot rod when moving from the upright position to the emptying position.

19. The debris collection hopper system of claim 16, wherein the hopper assembly is configured to move from the upright position to emptying position when the latching mechanism is released.

20. The debris collection hopper system of claim 16, wherein the base assembly comprises a plurality of wheels and a plurality of fork tubes, wherein each fork tube of the plurality of fork tubes is configured to receive a fork of a forklift.
